(19) United States
(12) Patent Application Publication
(10) Pub. No.: US 2001/0020956 A1
(43) Pub. Date: Sep. 13, 2001

(54) Graphic image design

(75) Inventor: Charles Clement Moir, Hemel Hempstead (GB)

Correspondence Address: Nixon & Vanderhye P.C., 8th Floor, 1100 N. Glebe Rd., Arlington, VA, 22201, US

(73) Assignee: ZYRIS PLC.

(21) Appl. No.: 09/755,201

(22) Filed: Jan. 8, 2001

Related U.S. Application Data
(63) Continuation of application No. 09/196,103, filed on Nov. 20, 1998, now abandoned.

(30) Foreign Application Priority Data
Dec. 9, 1997 (GB) 9726050.9

(51) Int. Cl. G06F 3/14

(52) U.S. Cl. 345/765; 345/764

(57) ABSTRACT

A user selects a graphic template from a library of graphic templates. The graphic template for a graphic object contains both predefined graphic parameters and user defined graphic parameters. A user is prompted to specify the user defined graphic parameters. Once both the user defined and predetermined graphic parameters are set, the vector graphic instructions from the now completed graphic template are rendered to produce a bitmapped graphic object that is at the same time anti-aliased against the background. The system is particularly useful for producing customised graphic objects for use of Internet web pages.

### BACKGROUND OF THE INVENTION

1. Field of the Invention

This invention relates to the field of graphic image design. More particularly, this invention relates to the use of data processing systems in producing graphic images.

2. Description of the Prior Art

It is known to use computers to generate graphic display defining data. An example of such graphic display defining data is that containing bitmap images of the type used on Internet web pages. The creation of high quality graphic images is a highly skilled task. One way of making high quality graphic images available to non-expert users is to provide a library of graphic bitmapped objects. Unfortunately, in order for such library images to be useful to a reasonably large number of users, they are of a general nature and are not customised to an individual user. An example would be a user seeking a graphic image in the form of a banner bearing the user's company name. A library of graphic objects would not contain anything so specific. Accordingly, the user would be forced either to employ a graphic designer to produce a specific high quality banner or themselves produce a banner having a more amateur appearance.

### SUMMARY OF THE INVENTION

Viewed from one aspect the present invention provides a method of generating graphic display defining data including one or more bitmapped graphic objects using a data processing apparatus for display on a display device, said method comprising the steps of:

(i) selecting from a library of graphic templates a graphic template having at least one predetermined graphic parameter and at least one user defined graphic parameter;

(ii) prompting a user to specify said at least one user defined graphic parameter; and

(iii) rendering said graphic template in dependence upon said at least one predetermined graphic parameter and said at least one user defined graphic parameter to generate a bitmapped graphic object for display.

Generating graphic images (e.g. the graphic images may be part of a file defining the content and appearance of one or more Internet web pages) in this way enables the design of a graphic image to be separated from its content, e.g. the artwork and aesthetic appearance of a logo can be separated from the text appearing within the logo thereby allowing an unskilled user to select the graphic template for the logo from a library and then adapt it to show the company name of the user whilst still benefitting from the original professional design of the logo.

It will be appreciated that the user defined graphic parameters could take many different forms, however in preferred embodiments of the invention, the user defined graphic parameters can be one or more of text data, font data, size, colour data, texture data, line thickness, line style, transparency value, transparency type, brightness, contrast, saturation or fill style.

The above selection of user defined graphic parameters are of a type that, depending upon the graphic object in question and as controlled by the professional designer, an unskilled user can alter relatively successfully without upsetting the overall professional design appearance of the graphic object originally created and embodied as the graphic template.

In a similar manner it has been found that it is preferable that the predetermined graphic parameters should include shape defining data, shading data, highlighting data, shadowing data, colour, transparency value or transparency type.

The above selection of predetermined graphic parameters have been found to be the ones that, depending upon the graphic object in question, if altered by an unskilled user can greatly deteriorate the appearance of the graphic object and so are best left unaltered from the original settings defined by the professional graphic designer when creating the graphic template.

Given the flexibility that this system allows in easily and rapidly changing the appearance of bitmapped graphic objects, it is preferred that the step of rendering includes anti-aliasing the bitmapped graphic object over a background.

The rapid and easy alteration of the bitmapped graphic objects would be significantly compromised if the quality of the image was not preserved by the rendering step correctly anti-aliasing the objects. Changes in colour and texture would have a marked effect upon the anti-aliasing required and accordingly would make the boundaries between the graphic objects and the background highly Visible.

In order to improve the consistency and accuracy of the changes made by an unskilled user, preferred embodiments of the invention are such that a number of similar graphics objects share related characteristics that can be changed together, i.e. said graphic display defining data includes a plurality of bitmapped graphic objects sharing at least one shared user defined graphic parameter, said method further comprising the steps of:

(i) changing a shared user defined graphic parameter;

(ii) identifying said plurality of bitmapped graphic objects dependent upon said shared user defined graphic parameter that has changed; and

(iii) re-creating said plurality of bitmapped graphic objects dependent upon said shared user defined graphic parameter that has changed.

Shared user defined graphic parameters allow a single change in this parameter to influence the appearance of a plurality of graphic objects so that the change is easily and accurately carried out throughout all the related graphic objects.

The usefulness of shared user defined graphic parameters can be further enhanced in embodiments in which said shared user defined graphic parameters are arranged in groups of shared user defined graphic parameters such that a change in a shared user defined graphic parameter at one point in the group can change linked shared user defined parameters of the group.

This grouping allows global styles to be defined for the whole of the graphic display defining data being prepared. For example, a collection of matching colours could be defined by the professional graphic designer with the unskilled user being allowed to choose between matching sets of colours that would then the applied to the groups of graphic objects below the colour set within the hierarchy. A colour could occur multiple times within a single graphic object, a plurality of graphic objects on a page or even a whole web site and then all linked instances of that colour changed together.

The same considerations that apply to shared user defined graphic parameters also apply to predetermined graphic parameters that can take the form of shared predetermined graphic parameters arranged in a hierarchy.

It will be appreciated that the bitmapped graphic objects could take a large number of forms. However, preferably the bitmapped graphic objects are one of a transparent GIF graphic object, a JPEG graphic object or a PNG graphic object.

Graphic objects having these bitmapped formats are capable of producing a highly sophisticated appearance that benefits from the skills of a professional graphic designer when producing the original graphic template and yet allow an unskilled user the ability to produce highly customised bitmapped graphic objects.

The graphic images produced by the invention are particularly useful as Internet web pages that are composed of many graphic objects that are desirably of a high quality and yet highly customised to the individual user's requirements.

In order to improve the ease of use by an unskilled user, it is preferred that at least one user defined graphic parameter has an associated prompt text stored therewith within said graphic template, said prompt text being displayed when prompting said user.

The prompt text can ask the user a simple question to which the answer is the user defined graphic parameter that needs to the specified.

Whilst the graphic templates could define graphic objects of very many different forms, the invention has been found to the particularly useful in embodiments of the invention where the graphic template is one of a logo, a banner or a button.

These types of graphic objects are ones that greatly benefit from the skills of a professional graphic designer and yet are highly specific to a given user and so need to be customised once they have been selected from the likely of graphic templates. It will be appreciated that a “button” refers to any graphic object used to trigger an action on the computer in response to a user input over the “button”.

It is desirable that the graphic templates should include default values.

In this way the graphic templates can be made self-contained without any user input being required before a bitmapped graphic object can be generated if the user accepts the default values. Furthermore, the default values can be set to produce an aesthetically pleasing result thereby reducing the likelihood that the unskilled user will pick completely inappropriate user defined graphic parameters.

The split between user defined graphic parameters and predetermined graphic parameters is preferably made that the stage at which the graphic template is being designed. At this stage, each parameter of the design is specified as being either user defined or predetermined.

Once the graphic images for display have been produced, it is possible that further alteration may be required at a later time. In order to cater for this possibility, it is preferred that the graphic templates are stored together with the graphic objects to permit editing of the graphic display defining data using the graphic templates.

Viewed from another aspect the present invention provides an apparatus for generating graphic display defining data including one or more bitmapped graphic objects using a data processing apparatus for display on a display device, said apparatus comprising:

(i) a memory storing a library of graphic templates a graphic template having at least one predetermined graphic parameter and at least one user defined graphic parameter;

(ii) a user input device for selecting a graphic template from said library;

(iii) a prompting device for prompting a user to specify said at least one user defined graphic parameter via said user input device; and

(i) a rendering mechanism for rendering said graphic template in dependence upon said at least one predetermined graphic parameter and said at least one user defined graphic parameter to generate a bitmapped graphic object for display.

The above, and other objects, features and advantages of this invention will be apparent from the following detailed description of illustrative embodiments which is to be read in connection with the accompanying drawings.

### BRIEF DESCRIPTION OF THE DRAWINGS

FIGS. 1A to 1G show example graphic objects.

FIG. 2 schematically illustrated the selection of a graphic template from a likely and the customisation of that graphic object;

FIG. 3 schematically illustrated a personal computer of the type which may be used to implement the invention;

FIG. 4 is a flow diagram illustrating the design of a graphic template; and

FIG. 5 is a flow diagram illustrating the use of a graphic template by that unskilled user to create a bitmapped graphic object.

### DESCRIPTION OF THE PREFERRED EMBODIMENTS

The ability to create quality original graphics, such as company logos or much of what you would typically find on web pages, is a rare one and really limited to professional graphic designers. The average man in the street does not possess either the artistic or technical skill to be able to originate professional quality images. So someone wanting graphics for brochures or web design either has to use off-the-shelf clipart, or use the services of a graphics designer to create what he wants. Off-the-shelf graphics is fixed, unchangeable, and even using the largest collections of pre-built clipart you are unlikely to find a graphics that exactly matches your requirements.

Web graphics, being limited to fixed bitmaps only, have an additional problem of not being anti-aliased to the background. In other words libraries of bitmap graphics either have no anti-aliasing and so are of poor quality, or they are anti-aliased to a fixed background colour, meaning you are not able to use them on top of backgrounds of any other colour without them looking bad.

The techniques described herein can be thought of as ‘smart graphics’ that reduce the above problems by separating the design from the content. The design aspect is left to experienced graphics designers, but the user can customise the graphics and so create images that are both high quality professionally designed and personalised. The graphics can also be correctly anti-aliased over any background so ensuring the highest quality at all times.

The system requires a graphic artist or designer to originate a graphics template. During the design process the artist decides which aspects of the graphics he will let the user customise or personalise. So, for example, he might design an elaborate, stylised logo containing an arbitrary company name. In this instance he marks the text name as user-customisable, but nothing else. When the user wants to use this particular graphic our system will ask the user to enter the required name, which is then rendered and incorporated into the graphic, resulting in a professional quality personalised logo that would otherwise require the skills of a graphic designer.

Another example. A user wants to use a particular graphic of a button on his web page. He wants a high quality 3D looking graphic with shading and highlights. Using traditional methods he would have to find a particular pre-designed graphic that has exactly the right text on the button, and one that was exactly the right colour and with the right texture, probably an impossible task. Alternatively he could ask a graphic designer to create a button, describing the text, the colour and the texture, and the designer could draw such a thing from scratch.

Using the ‘smart graphics’ system the user selects the button look from a library of examples, and the system asks him to enter the text to appear on the button and select the colour and the texture. It then generates the resultant GIF (or JPEG) graphic customised as he required.

Significant points concerning the system are:

Graphics creation that separates the content from the design. The graphic artist designs. The user specifies the content.

User requires little design skill, or knowledge of operating graphics software.

Creates high quality anti-aliased bitmap images.

Creates transparent GIF bitmaps anti-aliased over any background, and JPEG images containing the correct background of graphics to be altered or personalised, and for the entire set of graphics.

Allows coordinated collections of graphics to be changed automatically.

The ‘smart graphics’ system is based around object graphics (also knows as drawn or vector graphics), where the designer identifies and ‘marks’ which parts or elements of the drawing he will allow the user to alter. This drawing is saved in a special format along with the marked elements. When the user wishes to alter or personalise the image, the file is passed through a post processing stage that identifies the marked elements and asks the user simple questions allowing the user to alter just the marked items. The final stage is that this personalised version of the file is then passed to an appropriate rendering stage where the file is turned into the GIF or JPEG for use on the web page.

This system allows the designer to determine which parts of a drawing may be personalised. In this way the end-user does not have the liberty to alter the drawing in anything other than a controlled manner. Typically the designer would allow the user to alter any text in the graphic, or perhaps alter the ‘base’ colour or texture of the image, but nothing else.

The steps in the process can be considered as:

The designer creates the graphic using all the facilities of the vector graphic software.

The designer marks those parts of the drawing, or those characteristics of the drawing with a special indicator tag or attribute that indicates the elements that the user may alter. The system should allow the designer to mark not just drawn objects, but also the object's characteristics such as its fill style, colours, line width and all aspects that he might want to allow the user to adjust.

In addition the designer may want to attach a ‘user prompt’ with the object that can be used to provide a helpful prompt or question to the user when the file is processed afterwards.

In the case where a particular part of the drawing or characteristic of the drawing is common to other parts, and the user may wants to change all the parts together, then a ‘named graphic style’ can be created and applied to all the parts; i.e. take the case where a fill colour is common to a several parts of a drawing and the designer allows the user to alter this colour in a single operation and all occurrences of this style will be altered together. This can be consider analogous to the use of a ‘style’ in a word processor.

The file is saved in an appropriate format where attached markings of elements within the drawing are saved with the drawing. Using the program this is done by exporting the file in a format that can be used by later processing stages.

When the user wants to personalise or alter the image, the ‘template’ file is passed to a post processing stage that scans the file looking for marked items. For each marked item in the file the user is asked to adjust the value. So were a text object marked, then the user would be allowed to enter new text. Or were the colour of an item marked then the user would be allowed to adjust the colour. In all cases the user is presented with a series of questions. If the object being personalised has a ‘user prompt’ then this is the question asked of the user.

If the marked item is marked with a user named style, then the user is asked the question in the normal way, but for all subsequent occurrences of this style the same ‘answer’ is applied to each.

The marked elements are therefore altered as per the user instructions and a new processed and personalised version of the file is created.

Finally the file is passed to a rendering stage that converts it from the vector form into a bitmaps form (GIF, JPEG, PNG etc) suitable for use on the web. This stage will also use the appropriate background colour or texture, such as that from the web page, during the rendering stage to ensure that the image can be anti-aliased to the correct background and that, in the case of JPEG files, the correct background can be included in the JPEG.

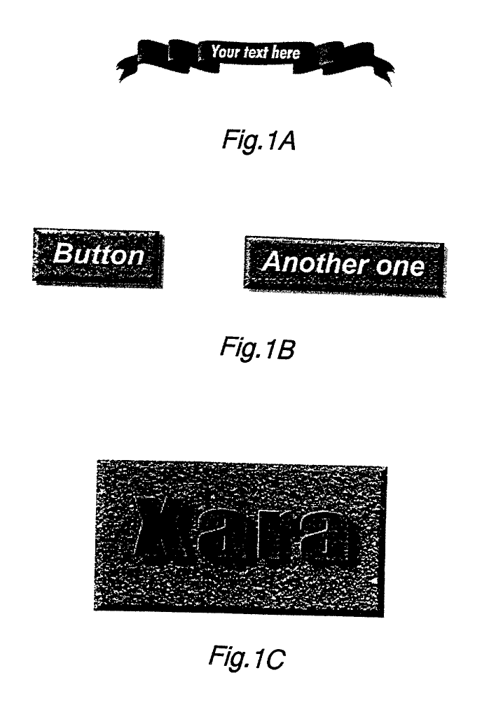

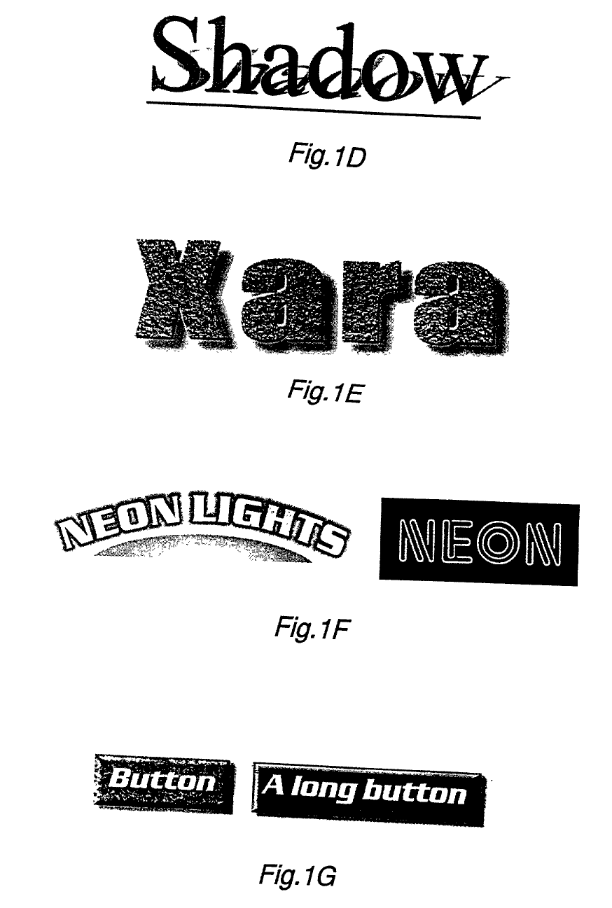

Here are some example images:

[see FIG. 1A]

A simple example where the user simply alters the text. The scroll can be made to elongate to take account of the text length, so that this provides more than a simple text substitution. The shading of an image like this is key to its appearance and is handled automatically. The colour of the scroll may be a user defined parameter. In this case the colour may be altered without having to recreate the shading to make it look correct.

[see FIG. 1B]

A 3D shaded button such as these are not uncommon on web pages, but require some design skill and are time consuming to create. Using the smart graphics system the designer would specify that the background texture bitmap and the text would be user replaceable. The highlighting and shading on the button can be achieved by using coloured transparency overlays, in such a way that the replaced bitmap or texture will maintain the correct shading. The present system also allows bitmap colouring so that the user could retain the bitmap, but just alter its colour.

A point to note about the above images is that the buttons have a soft shadow—and the system would correctly render this soft shadow over any background.

The button example is one where it's likely that a number of similar related buttons will be used throughout the web site. By using a common site style naming convention the system could automatically alter all similar buttons on the site.

[see FIG. 1C]

The above example is another case where a soft shadow exists being rendered over a textured background—which could just as well be the page background. If the designer allowed the user to alter only the text, then the smart graphic system would replace the lettering, while maintaining the correct soft shadow, the white edge highlight, the correct bitmap texture filling the word and the correct white reflection that covers part of the text. There is no other graphics system around that provides this sort of flexibility.

[See FIG. 1D]

This example has a simple cast shadow that fades into the distance. The user defined parameter in this case would be the text. Altering the text would replace both the upright and slanted shadow versions thereby allowing quick and easy creation of text heading with an artistically correct shadow.

[See FIG. 1E]

This example would typically have two user defined parameters. First the bitmap texture inside the wording would be alterable, with the user probably being able to select from a number of pre-supplied textures.

Secondly the text would be alterable. The soft edged shadow behind the text is usually quite a tricky and time consuming effect to achieve, and of course this has to be the same shape as the main letters. As with the above example, this is a case where multiple items within the single drawing have to be changed together—in this case the main letters, the slight embossing effect given to the letters (the black edge) and the soft shadow itself. Therefore all these items would be marked with a common “style” to indicate that when the user alters the lettering, that all copies are changed.

[See FIG. 1F]

These two examples use a similar technique to create a glow effect around some text. The user definable parameters in both cases would include the colour—so the user could easily create a red neon or blue neon effect around the text. Secondly, as usual the text itself would be a user definable parameter. As with the other examples the glow effect is made from the same letter shapes as the main text and so the text and the glow parts of the drawing need to be marked with a common style to make sure all the parts change in sync.

Another possible user definable parameter would be the size of the glow, which in this case is achieved by altering line thickness. This would be achieved by marking the line thickness as user-definable in the template file.

[See FIG. 1G]

These two examples illustrate one example graphic template which has two user defined parameters. The button texture is altered from the first example to the second (in the first example the button has a fractal like texture, in the larger button the texture is replaced with a flat colour). Secondly the button text is user-alterable. This example shows off the smart button re-sizing that is possible when the text length changes.

As a result of offering just these two user-definable parameters, the button texture and the wording, the user can create a huge range of custom, personalised, yet high quality (with shading, highlights, drop shadow) buttons in a few seconds.

It is common that graphics on a web page or web site are designed as part of a coordinated look and feel. That is the graphics are typically colour co-ordinated and style coordinated, often of a consistent size to provide the whole page or site with a professional consistent look and feel. These items can be referred to as site style items or elements, i.e. they form part of the overall look and feel theme of the site.

On a conventional web site, there is no way a designer can easily alter elements that occur throughout a site. At a minimum it would require the graphics designer to revert to the original graphic authoring program, find the original images and alter each one that appears on the entire site. Since web graphics are bitmaps, typically a designer will not have ‘originals’ and will have to re-create new bitmaps from scratch. If the web site owner is not the designer (common) then there is just no way they can alter any aspects of the graphic look and feel, without having the expertise to re-create the graphic from scratch. Additionally if the site was made from pre-built collection of GIF images say from one of the many image collections available, then again there is just no way the designer or user can alter a certain aspect such as the colour of all the buttons.

Our system lets the designer, or indeed anyone (it doesn't have to be the original site designer) to alter the site style elements, such as the colour of all the buttons, or texture bitmap that may be used in a number of different elements on the page, in a single operation.

The above solution marks elements that form part of the site style in the original graphic files. These files must be object or element based, typically vector files and are stored, along with the site-style marks associated with the site-style elements. When the user requires to alter a certain site-style aspect, such as a texture bitmap used in a number of different places or images on the web site, we have a program that locates the affected images, changes the site-style elements and then re-creates the GIF, JPEG or PNG files for use on the web.

Site-styles are an extension of the ‘smart graphics’ style. In ‘smart graphic’ case designers marked those elements of a graphic that the user could change. In the site-style case the designer marks those elements that are common to graphics across a whole site.

This is a (non-exhaustive) list of elements or attributes of graphics that would typically be marked as user-editable site-style elements;

Background texture or colour

Textures (i.e. bitmaps used for fill-styles in a number of different places)

Button sizes

Fonts

Site style colours (a site style may consists of a number of ‘theme’ colours rather than just one)

Text (it's possible someone may want a word, logo or whatever, to be changed in all places on a web site) An important point is that the designer chooses precisely which elements he decides are site-styles. It may be a very restricted set, e.g. he may only want users to alter something like the font-name used on all the buttons on the site.

Assuming the designer has already created the graphic images and marked them with appropriate site-style names, when the user wants to alter a site-style element, software has to go through the process of identifying all graphics containing site-style elements, and altering those elements, re-creating the GIF or JPEG image and substituting these for the original bitmap files on the web site.

There are a number of ways in which this algorithm can be implemented, e.g. scanning all the pages of the web site for image files that have been created from the ‘smart-graphic’ system, then scanning all the original master ‘smart-graphic’ files for the site-style elements (the simple but slow way). Or perhaps we would maintain a central data-structure knowing the location of all the ‘smart-graphics’ used on a site, along with the HTML pages, the destination GIF location and a list of styles contained in each. (the advanced but fast way). Similar to the table documented elsewhere.

It is necessary to allow designers to restrict the range of colours that user can select for certain edit operations. The design goal of ‘making it difficult for users to make a mess’ requires that they cannot easily mix clashing colours. We do this through a style naming convention as well, e.g. when specifying that colours are user editable (either as site-styles, or as an image style).

The above can use the inherent abilities of known systems to handle shades as an additional style mechanism, i.e. when the user alter a colour that is a ‘master shade’ or linked colour then all affected colours will be adjusted automatically.

The system does not just rely on site-styles as the only indication that an element may be required to change throughout a web site. If a particular graphic is used in numerous places and the user alters it, then the system asks the user whether he wants all other occurrence of this button altering, or just this one.

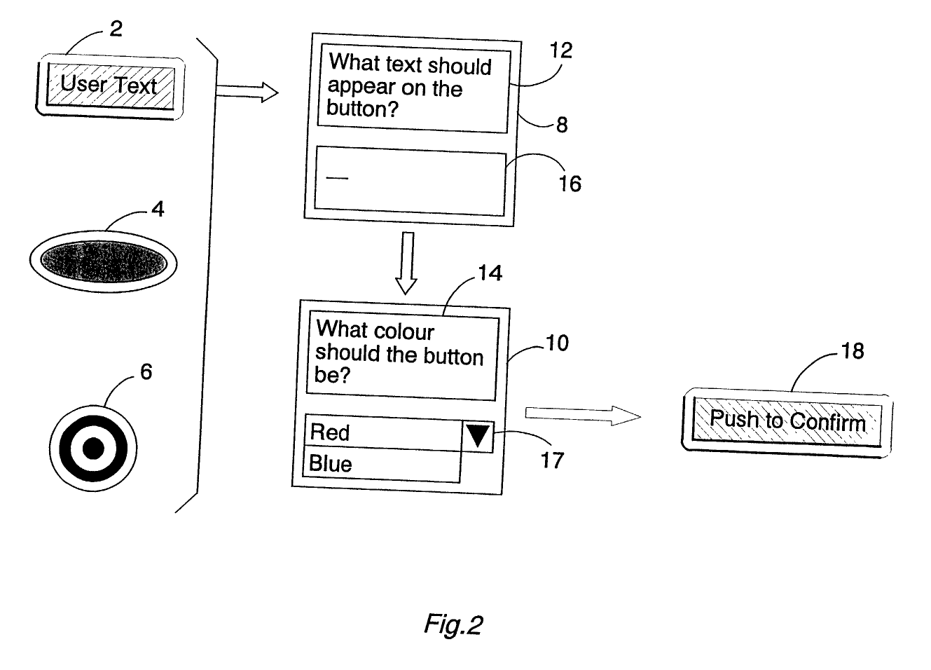

FIG. 2 shows three graphic templates 2,4,6 that have been rendered using the default user defined graphic parameters to ease the selection by the user. In this case the user selects graphic template 2 as being the one that most closely matches the appearance that the user wishes to achieve. The graphic template selected is then passed to a post-processing stage where the user is asked a series of questions to lead the user through the choices possible for the various user defined graphic parameters.

In this example, the questions are presented as a sequence of dialogue boxes 8,10. Each of these dialogue boxes 8,10 includes a respective prompt text 12,14. The first prompt text 12 asks the user to specify the text that should appear on the button 2. The user enters the desired text within a text input box 16. The text is unconstrained. The second prompt text 14 asks the user to specify the colour of the button 2. In this example, this choice is not unconstrained, but is limited to those preselected by the designer as suitable. In this example, the available colours are displayed via a pull-down list 17.

The colour specify could be a shared colour, for example, all the buttons on the graphic image being prepared could share a common colour that would be specified at this stage.

It will be appreciated that typically many further more sophisticated parameters of the button 2 could be user defined via such dialogue boxes. However, in this example the remaining parameters of the graphic template for the button 2 are all predetermined graphic parameters. Accordingly, after the second dialogue box 10 has been dealt with, all of the parameters required have been specified and the graphic template can be rendered to produce the desired bitmapped graphic object 18. The rendering that takes place at this stage converts a vector graphic object into a bitmapped graphic object. The template can also include rendering information (such as number of colours, dithering system, JPEG compression value, etc) determined by the professional designer to give the best results, e.g. most suitable for transmission via the Internet. Accordingly, it is possible and appropriate that this stage to anti-alias the bitmapped graphic object against the underlying background using one of the known algorithms for anti-aliasing.

The bitmapped graphic object 18 shown differs from the version using the default settings in that the text of the button has been altered to “Push to Comfirm” and the colour has been changed from red to blue. The likelihood of finding a button having this combination of text and colour as a predefined object within a standard library of graphic objects is highly remote and so the strong advantage of the invention in allowing a professionally designed button to be readily modified to match the requirements of the user whilst retaining the quality appearance achieved by the professional designer may be easily seen.

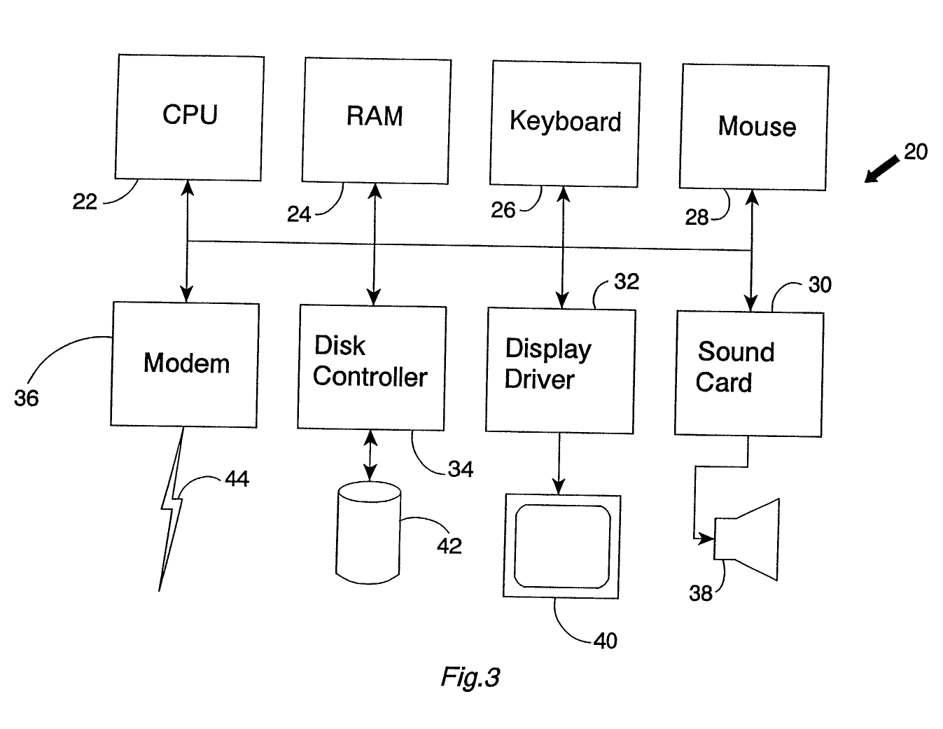

FIG. 3 schematically illustrates a personal computer 20 that may be used to implement the present invention. It will be appreciated that many different types of computer could be used instead of a personal computer. For example, a client-server system could be used. In such a client-server system the client computer could be a thin-client (e.g. a NC) communicating with a server computer via the Internet.

Returning to the personal computer 20 shown in FIG. 2,this comprising a central processing unit 22 coupled via a bus to a random access memory 24,a keyboard 26,a mouse 28,a sound card 30,a display driver 32,a disk controller 34 and a modem 36. The sound card 30,the displayed driver 32,the disk controller 34 and the modem 36 respectively communicating with a loud speaker 38,a display monitor 40,a disk drive 42 and a telephone line 44.

In operation, the central processing unit 22 operates under control of program instructions stored within the random access memory 24 and recovered from the disk drive 42. The data being manipulated (such as the graphic templates and various user defined and predetermined graphic parameters) is also stored within the random access memory 24 and recovered from the disk driving 42. The algorithms for converting the vector graphic object defined by the graphic template into a bitmapped graphic object are well known. The anti-aliasing performed between the bitmapped graphic object and the background also made use known anti-aliasing algorithms. The organising and specification of the predetermined and user defined graphic parameters in accordance with the above described technique prior to the rendering and anti-aliasing gives rise to significant advantages.

An example of the type of data stored within a graphic template is given in the following table:

| | Predetermined or User | |
|---|---|---|
| ITEM | Defined | Additional Data |
| Vector Outline | P | |
| Width | P | Sized to fit user text |
| Height | P | Sized to fit user text |
| User Text | UD | “What text should appear |
| | | on the button?” |
| Shading | P | |
| Highlighting | P | |
| Font | P | |
| Colour | UD | “What colour should the |
| | | button be?” |
| Texture | P | |

The above table corresponds to be button 2 of FIG. 2. In this case, the graphic template includes only two user defined graphic parameters that each are accompanied by an associated prompt text. In order to take account of the variable length of the user text, the width of the button is specified as being sized to fit the user text. Depending upon the font being used (may be specified as part of a global style for the graphic image), the height of the button is similarly sized to fit the user text. The remainder of the graphic parameters shown in the table are predetermined. The vector outline defines the shape of the button including its rounded edges. The shading and highlighting parameters need careful setting and accordingly are best left unaltered from those originally chosen by the professional graphic designer who created the graphic template for this button.

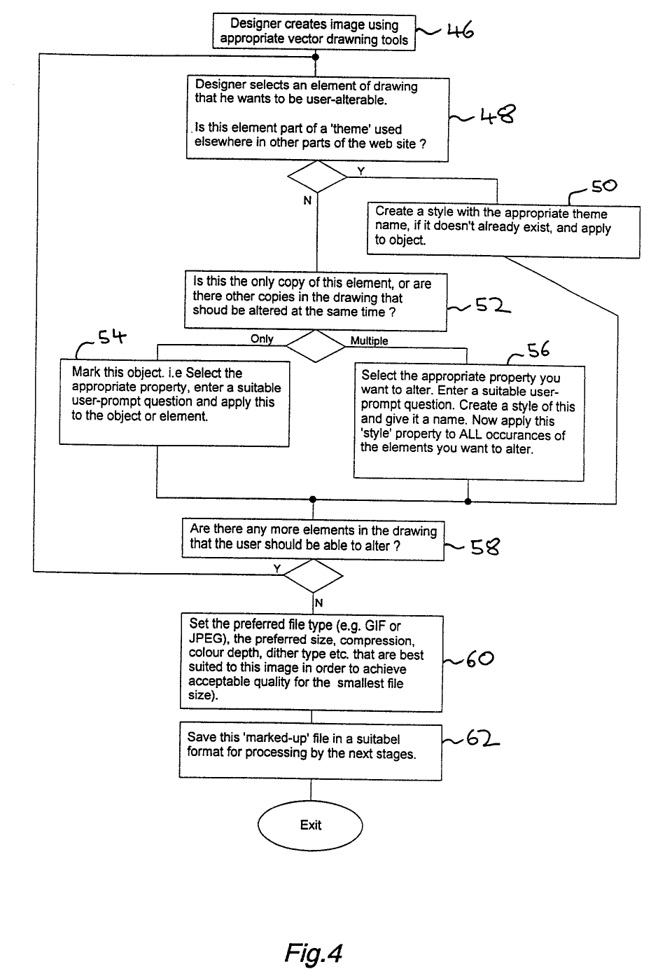

FIG. 4 is a flow diagram illustrating the design of a graphic template. Step 46 corresponds to the creation of the graphic template with all of its default parameters set using conventional vector drawing tools. At step 48,the designer selects a graphic parameter that he wishes to the user defined. A check is then made to select if the graphic parameter is to be part of a “theme” (a shared user defined graphic parameter of a high level in the hierarchy of user defined parameters). If the parameter is to be part of a theme, then, at step 50, either it is linked to an existing theme of shared parameters which it will follow, or a new theme of shared parameters is created such that further parameters can be linked to it in due course.

If the parameter is not part of an “theme”, then a check is made at step 52 as to whether this is to be the only copy of this parameter so that it is individually specified, or alternatively, that this parameter is to be shared (multiple copies exist).

If this is a single occurrence parameter, then it is marked as individually user defined at step 54 and a suitable prompt text is entered. If multiple copies of this parameter exist (a shared user defined parameter), then at step 56,this is set up as a shared user defined parameter with an associated prompt text and this “style” property is then applied to all the occurrences of that parameter as selected.

At step 58 the graphic designer determines whether or not any further parameters should be marked as user defined. If more parameters are to be marked, then processing returns to step 48. Otherwise, processing proceeds to step 60 at which stage parameters concerning the rendering of the graphic object from vector form to bitmapped form are set, for example, file type, compression value, colour depth, colour reduction method, number of colours to reduce to or dithering method.

Finally, at step 62,the vector specified graphic object is converted to a graphic template form that can be processed to trigger the prompting of the user for the required user defined graphic parameters.

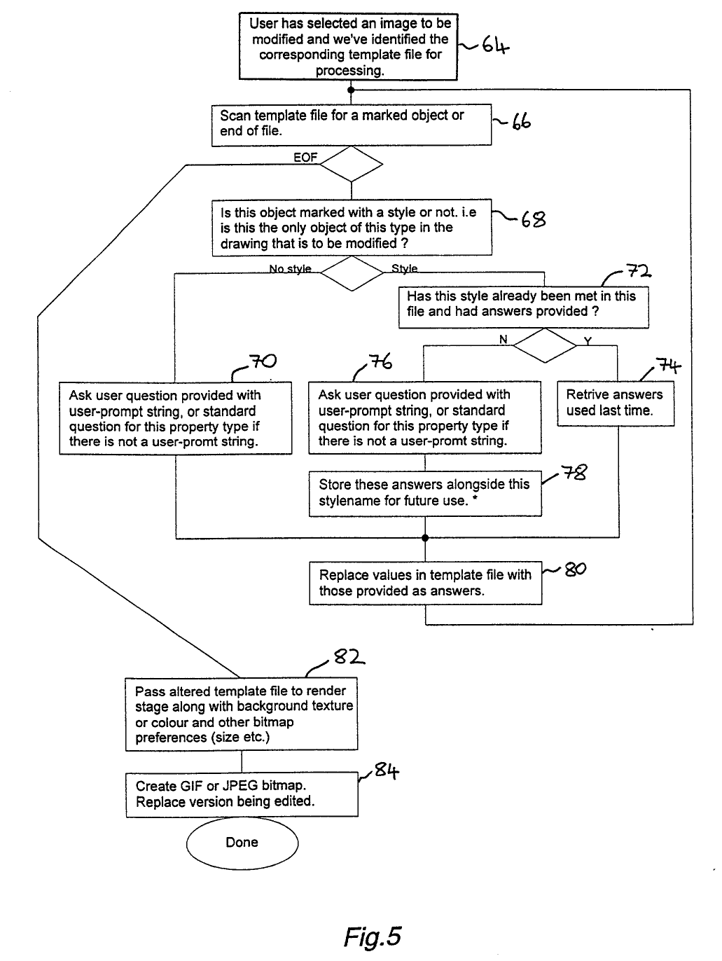

FIG. 5 is a flow diagram illustrating the selection and customisation of a graphic template from a library of graphic templates. At step 64 the user selects a graphic template to be modified from a library of graphic templates by picking an image from among a collection of images generated using the default parameters as shown for a selection of buttons in FIG. 1. Instead of a collection of buttons, a collection of logos or banners might be displayed. Other types of graphic object are also suitable for modification using the present technique.

At step 66, the graphic template file is scanned to identify items marked as involving user defined graphic parameters. When the end of the graphic template file is reached, processing proceeds to steps 82 and 84 where rendering of the bitmapped graphic object takes place. When an item is identified that incorporates a user defined graphic parameter, processing proceeds to step 68.

At step 68,a check is made to see if the user defined graphic parameter is a shared graphic parameter (is a style parameter shared with other graphic objects). If the user defined graphic parameter is shared, then processing proceeds to step 72.

At step 72,if the shared user defined graphic parameter has already been met within the generation of this graphic image, then the previously specified value for that parameter is retreat at step 74. Otherwise, at step 76 the user is prompted with the prompt text to specify the value of the shared user defined graphic parameter. At step 78,this specified shared parameter is then stored together with the corresponding style name such that when that style name is next encountered, the already defined value can be used without requiring further user input.

At step 80,the value for the graphic parameters determined in steps 68 to 78 are inserted within the template file to create a customised template file that proceeds to rendering at steps 82 and 84.

At step 82, the template file (a vector graphic definition) is passed to a vector graphic rendering algorithm from where the bitmapped graphic image together with the background texture and colour that the bitmapped graphic image will overlie are passed to an anti-aliasing mechanism in order to make the boundary between the bitmapped graphic image and the background less visible. At step 84,the final bitmapped graphic image is output in the form of a GIF or JPEG file. The graphic template file including all of the user defined graphic parameters can be stored together with the bitmapped graphic image to facilitate subsequent editing.

In a broad sense at least preferred embodiments of the invention individually or in combination provide a system that:

allows designer specified, user customisation of graphic images;

allows “theme characteristics” to occur across multiple images that occur within a web site or document of any kind, and that when a user alters this “theme characteristic” that all affected images are changed as appropriate;

allows common graphics characteristics within a single image to be marked by the designer to be user-altered together, e.g. text and its drop shadow; and

can anti-alias the resultant graphics over different backgrounds.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim

1. A method of generating graphic display defining data including one or more bitmapped graphic objects using a data processing apparatus for display on a display device, said method comprising the steps of:
(i) selecting from a library of graphic templates a graphic template having at least one predetermined graphic parameter and at least one user defined graphic parameter;
(ii) prompting a user to specify said at least one user defined graphic parameter; and
(iii) rendering said graphic template in dependence upon said at least one predetermined graphic parameter and said at least one user defined graphic parameter to generate a bitmapped graphic object for display.

2. A method as claimed in claim 1, wherein said user defined graphic parameter is one of text data, font data, size, colour data, texture data, line thickness, line style, transparency value, transparency type, brightness, contrast, saturation or fill style.

3. A method as claimed in claim 1, wherein said predetermined graphic parameter is one of shape defining data, shading data, highlighting data, shadowing data, colour, transparency value or transparency type.

4. A method as claimed in claim 1, wherein said step of rendering includes anti-aliasing said bitmapped graphic object over a background.

5. A method as claimed in claim 1, wherein said graphic display defining data includes a bitmapped graphic object having a plurality of components sharing at least one shared user defined graphic parameter, said method further comprising the steps of:
(i) changing a shared user defined graphic parameter;
(ii) identifying said plurality of components dependent upon said shared user defined graphic parameter that has changed; and
(iii) re-creating said bitmapped graphic objects dependent upon said shared user defined graphic parameter that has changed.

6. A method as claimed in claim 5, wherein a plurality of bitmapped graphic objects share said shared user defined graphic parameter.

7. A method as claimed in claim 1, wherein said bitmapped graphic objects resulting from said rendering are one of a transparent GIF graphic object, a JPEG graphic object or a PNG graphic object.

8. A method as claimed in claim 1, wherein said graphic images for display are Internet web pages.

9. A method as claimed in claim 1, wherein at least one user defined graphic parameter has an associated prompt text stored therewith within said graphic template, said prompt text being displayed when prompting said user.

10. A method as claimed in claim 1, wherein said graphic template defines one of a graphic heading, a graphic banner or a graphic button.

11. A method as claimed in claim 1, wherein said graphic templates include default values for said user defined graphic parameters.

12. A method as claimed in claim 1, wherein when defining said graphic templates each parameter is identified as either a predetermined graphic parameter or a user defined graphic parameter.

13. A method as claimed in claim 1, wherein said graphic templates are stored within said graphic display defining data to permit editing of said graphic images using said graphic templates.

14. A method as claimed in claim 1, wherein said user defined graphic parameter is text data and said graphic template includes one or more further characteristics of said graphic object that are resized in dependence upon changes in the length of said text data.

15. A method as claimed in claim 1, wherein said predetermined graphic parameter is rendering data specifying variable parameters in said rendering.

16. A method as claimed in claim 15, wherein said rendering data includes at least one of colour reduction method, compression value, image file type, number of colours to reduce to or dithering method.

17. An apparatus for generating graphic display defining data including one or more bitmapped graphic objects using a data processing apparatus for display on a display device, said apparatus comprising:
(i) a memory storing a library of graphic templates a graphic template having at least one predetermined graphic parameter and at least one user defined graphic parameter;
(ii) a user input device for selecting a graphic template from said library;
(iii) a prompting device for prompting a user to specify said at least one user defined graphic parameter via said user input device; and
(i) a rendering mechanism for rendering said graphic template in dependence upon said at least one predetermined graphic parameter and said at least one user defined graphic parameter to generate a bitmapped graphic object for display.
